(19) United States
(12) Patent Application Publication
(10) Pub. No.: US 2026/0187372 A1
(43) Pub. Date: Jul. 2, 2026

(54) Machine-Learning Systems and Methods Including Retrieval Augmented Generation

(71) Applicant: Google LLC, Mountain View, CA (US)

(72) Inventors: Deep Narayan Dubey, Kirkland, WA (US); Yuening Hu, Palo Alto, CA (US); Ricardo Andres Zilleruelo Ramos, Sunnyvale, CA (US); Sungyong Seo, Sunnyvale, CA (US); Guangsha Shi, Sunnyvale, CA (US); Shining Yu, Sunnyvale, CA (US); Neda Mirian, Sunnyvale, CA (US)

(21) Appl. No.: 19/005,660

(22) Filed: Dec. 30, 2024

(51) Int. Cl. G06F 40/289; G06F 40/169; G06F 40/205; G06F 40/40

(52) U.S. Cl. CPC G06F 40/289; G06F 40/169; G06F 40/205; G06F 40/40

(57) ABSTRACT

Aspects of the disclosed technology include machine-learning systems and methods for generating an index for machine-learning retrieval augmented generation systems. The method can include accessing a set of documents and for each document in the set of documents, parsing the electronic document into a hierarchical representation based on a layout schema, generating a plurality of document chunks from the electronic document based at least in part on the hierarchical representation, generating at least one annotation for at least one document chunk in the plurality of document chunks, and storing, in a document retrieval index, the plurality of document chunks including the at least one annotation for the at least one document chunk in the plurality of document chunks.

### FIELD

The present disclosure relates generally to machine learning processes and machine-learned devices and systems. More particularly, the present disclosure relates to retrieval augmented generation for machine-learning systems.

### BACKGROUND

Artificial intelligence systems increasingly include large foundational machine-learned models which have the capability to provide a wide range of new product experiences. As an example, machine-learned generative models have proven successful at generating content including text, images, video, audio, computer-executable code, etc. For example, a user may formulate a user query into a prompt which is provided as an input to the generative model. The generative model can generate a response including generative content. To supplement the embedded knowledge of machine-learned models, retrieval augmented retrieval (RAG) systems are often used to retrieve supplementary content that can be provided to the model with a user query and/or other information in an input prompt. Many machine-learned models, such as large-language models (LLMs) and other sequence processing models, include a limited context window or a limited number of input tokens that they are able to receive.

While RAG systems are able to provide improvements to the knowledge capabilities of trained machine-learned models, traditional approaches are not always effective at retrieving and providing the most relevant information to the models, leading to underperformance in model effectiveness.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method performed by a computing system including one or more computing devices for generating an index for machine-learning retrieval augmented generation systems. The method includes accessing a set of documents and for each document in the set of documents, parsing the document into a hierarchical representation based on a layout schema, generating a plurality of document chunks from the document based at least in part on the hierarchical representation, generating at least one annotation for at least one document chunk in the plurality of document chunks, and storing, in a document retrieval index, the plurality of document chunks including the at least one annotation for the at least one document chunk in the plurality of document chunks.

Another example aspect of the present disclosure is directed to a computing system including one or more processors, and one or more non-transitory computer-readable storage media that collectively store instructions that, when executed by the one or more processors, cause the one or more processors to perform operations. The operations include accessing a set of documents and for each document in the set of documents, parsing the document into a hierarchical representation based on a layout schema, generating a plurality of document chunks from the document based at least in part on the hierarchical representation, generating at least one annotation for at least one document chunk in the plurality of document chunks, and storing, in a document retrieval index, the plurality of document chunks including the at least one annotation for the at least one document chunk in the plurality of document chunks.

Yet another example aspect of the present disclosure is directed to one or more non-transitory computer-readable storage media that store instructions that, when executed by one or more processors, cause the one or more processors to perform operations. The operations include accessing a set of documents and for each document in the set of documents, parsing the document into a hierarchical representation based on a layout schema, generating a plurality of document chunks from the document based at least in part on the hierarchical representation, generating at least one annotation for at least one document chunk in the plurality of document chunks, and storing, in a document retrieval index, the plurality of document chunks including the at least one annotation for the at least one document chunk in the plurality of document chunks.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including a machine learning system and retrieval augmented generation system according to example embodiments of the present disclosure;

FIG. 2 is a block diagram depicting an example computing environment, illustrating an example of processing of a set of documents by a retrieval augmented generation system according to example embodiments of the present disclosure;

FIGS. 3A and 3B depict an example of content (e.g., an image) and an example of a hierarchical representation of the content including entities and relationships in accordance with an example embodiment of the present disclosure.

FIG. 4 is a block diagram depicting an example computing environment, illustrating an example of processing a query by a retrieval augmented generation system according to example embodiments of the present disclosure;

FIG. 5 is a flowchart diagram depicting an example method of generating a document retrieval index for a retrieval augmentation generation system according to example embodiments of the present disclosure;

FIG. 6 is a flow chart diagram illustrating an example method of training a machine-learned model according to example embodiments of the present disclosure;

FIG. 7 is a block diagram of an example processing flow for using machine-learned model(s) to process input(s) to generate output(s) according to example embodiments of the present disclosure;

FIG. 8 is a block diagram of an example sequence processing model according to example embodiments of the present disclosure;

FIG. 9 is a block diagram of an example technique for populating an example input sequence for processing by a sequence processing model according to example embodiments of the present disclosure;

FIG. 10 is a block diagram of an example model development platform according to example embodiments of the present disclosure;

FIG. 11 is a block diagram of an example training workflow for training a machine-learned model according to example embodiments of the present disclosure;

FIG. 12 is a block diagram of an inference system for operating one or more machine-learned model(s) to perform inference according to example embodiments of the present disclosure;

FIG. 13 is a block diagram of an example networked computing system according to example embodiments of the present disclosure;

FIG. 14 is a block diagram of an example computing device according to example embodiments of the present disclosure; and

FIG. 15 is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, the present disclosure is directed to machine-learning systems and more particularly, machine-learning systems including retrieval augmented generation systems for generative models such as sequence processing models including large language models. In accordance with example embodiments, a retrieval augmented generation system can include a document retrieval index that stores for a particular document, a plurality of document chunks that are optimized for retrieval augmented generation. More particularly, the retrieval augmented generation system can generate the document retrieval index by parsing the document into a hierarchical layout (e.g., tree) structure, generating the plurality of chunks for the document based on the hierarchical layout structure, and annotating the document chunks for better understanding of the chunk content to assist with downstream tasks such as search, etc. The document chunks and annotations can be stored in the document retrieval index. In response to a query for a sequence processing model, the retrieval augmented generation system can access the document retrieval index and retrieve one or more document chunks that are relevant to the query. The system can provide the one or more document chunks and the query as input to the sequence processing model. The sequence processing model can process the one or more document chunks and the query to generate an output that is augmented by the retrieved document chunks.

Retrieval augmented generation (RAG) is a technique that combines generative models such as large language models (LLMs) with a retrieval system to access and process external information. Instead of relying solely on the knowledge embedded within the LLM, RAG allows the model or system to retrieve relevant documents or data from a knowledge base before generating a response. This improves the accuracy, factual consistency, and overall quality of the generated text by grounding the LLM's output in specific, verifiable information.

Generative models such as large language models are often constrained by their architecture, which limits the amount of data (e.g., text, image data, etc.) they can process simultaneously. Large language models have a limitation in that they can only process a finite amount of input data at once. This constraint, often expressed as a context window or token limit, restricts the size of the text or data the model can consider during a single processing step. To address the limited context window, techniques like chunking or summarization are often used to manage the input. However, these techniques can potentially impact the model's ability to understand the complete context and generate optimal outputs.

Chunking in retrieval augmented generation (RAG) involves dividing a large document into smaller, more manageable segments or “chunks” before providing them to a large language model (LLM). This addresses the LLM's limited context window, allowing the model to process information that would otherwise exceed its capacity. Typically, chunking is performed by dividing a document into multiple chunks where each chunk is equal to or less than the maximum token size input of the LLM. Traditionally, documents have been divided into chunks in a sequential manner by electing content sequentially until the maximum token size is reached.

In accordance with example embodiments of the present disclosure, documents can be parsed, chunked, and annotated to maintain semantic coherence within each chunk, preserving the relationships between sentences and paragraphs, while also ensuring that chunks are of an appropriate size for LLM processing. This improves the accuracy and relevance of the information retrieved and used by the LLM to generate a response. Documents that are meant for human consumption, contain visual cues to provide context while reading the document. For example, the document title, page header and footer, section headings, etc. provide useful information to understand the content. Dividing documents without reference to this information can lead to ineffective retrieval and/or failures to provide appropriate contextual information to the LLM. While LLMs are powerful tools to understand document content, they can be limited by their context window (token size limit) and in the presence of longer context windows, be distracted with irrelevant information contained in it.

According to example aspects of the present disclosure, a retrieval augmented generation (RAG) system is provided that is configured to parse a document's layout into a hierarchical tree structure, generate a plurality of document chunks from the document based on the layout structure, and to add annotations to the document chunks for better understanding of the chunk content to help with downstream understanding tasks such as search, retrieval, summary generation, and answer generation, etc. The system can access a set of documents and generate a document retrieval index to be used for retrieving content that is provided to a sequence processing model with an input query. For each document, the system can parse the electronic document into a hierarchical representation based on a layout schema. The system can then generate a plurality of document chunks from the electronic document based on the hierarchical representation. Annotations can be generated for one or more document chunks. The system can store the plurality of document chunks including the at least one annotation for the at least one document chunk in the plurality of document chunks.

According to an example aspect of the present disclosure, a machine learning system is provided for improved retrieval augmented generation (RAG) systems by optimizing document indexing for efficient and accurate information retrieval. The system can parse input documents (e.g., HTML, DOCX, PDF) into a hierarchical tree structure using a common layout schema. The system can support various document formats using appropriate parsing techniques (e.g., leveraging tags for markup languages, OCR and native parsing for PDFs). The layout schema can include a plurality of block types such as text, table, list, and image block types, with hierarchical relationships between them. This structured representation can facilitate the generation of semantically coherent document chunks, each containing interconnected content from the hierarchical layout. The chunking process respects LLM token limits, splitting or otherwise dividing large blocks while preserving structural integrity. By way of example, the system can keep table rows together. Oversized structures, such as large tables or sections, can be handled by splitting or dividing content into document chunks with structure preservation, or information aggregation to ensure relevant information is retained within chunk size limits. Layout content and/or document chunks can be annotated with information to aid in retrieval and input to the sequence processing model. In example embodiments, a document chunk can be annotated with LLM-generated questions that are answerable from the chunk content and keywords to enhance retrieval. The resulting chunks can be stored in a retrieval index, allowing both token based and embedding based searches to retrieve relevant information for a given query. This approach creates a document retrieval index containing optimized chunks and annotations, improving RAG system precision and recall by providing the LLM with relevant, concise, contextually rich information.

The RAG system can include a layout parser that is configured for layout parsing of input documents. The layout parser can utilize different parsing techniques depending on the input document format. For markup languages like HTML, DOCX, for example, the system can utilize the tags in the input document to understand the document structure and represent the structure in an internal layout schema. For PDF documents, the system can utilize OCR and native PDF parsing logic to parse the document structure and represent it in the internal layout schema.

The layout schema can include a common schema for all input document formats and can support the hierarchical representation of document layout. According to example embodiments, the schema can include a plurality of block types. For example, the schema can include text blocks, table blocks, list blocks, and/or image blocks. In accordance with some implementations, the table block and list block can contain the natural hierarchy of the content. The table block can contain table rows and cells. The list block can contain the list items. An image block can contain either a link to an image or the actual binary encoding of the image extracted from a document. The image block can contain annotations derived from the image content which can be useful to the retrieval of the image and for providing text context to non-multimodal models. In some examples, the layout schema can include different text block types. For example, a text block can be of type paragraph, heading, page header and footer. In some examples, a text block can include or contain other blocks as children, thereby creating a hierarchical representation. Hierarchy for the text block can be created using the information about previous heading blocks. For example, if a paragraph is detected, the system can check if there are unclosed heading blocks (suppose H1 and H2) before the paragraph and create a hierarchical representation (H1->H2->paragraph).

The RAG system can include a chunking engine that is configured to generate document chunks from an input document based on the hierarchical tree structure generated by the layout parser. The chunking engine can utilize the common layout representation from the layout parsing and create document chunks based on the hierarchical structure. By way of example, the chunking engine can generate document chunks by keeping interconnected content together, thereby producing information dense, rich and concise chunks. Document chunks can be created with content from parsed blocks from layout parsing. By way of example, a document chunk can include content from a reasonable subtree structure of the hierarchical layout. If a paragraph block contains too many tokens, the paragraph can be split into multiple chunks so that each chunk will contain the content from headings and paragraphs up to the token size limit. The chunking engine can be configured to provide semantically coherent document chunks. By way of example, a table block can be placed in the same chunk, to the extent possible, rather than merging it with other blocks by splitting it to meet the token limit unnecessarily. The chunking engine can use the known structure preserved in the layout representation to transform the structure, such as summarizing content across a large section, splitting single tables into multiple tables, but preserving headers and related rows and columns together, or aggregating and selecting information (Co-Table), so relevant information is preserved even as the original content is split and reduced in terms of tokens used.

The RAG system can include an annotation engine that is configured to annotate document chunks and/or layout information. For example, a document chunk can be annotated with LLM-generated questions answerable from the chunk content and keywords to enhance retrieval in example embodiments. In some examples, large sections and tables can be summarized in order to improve retrieval and provide useful context information to downstream components. In some examples, images can be annotated with questions that can be answered with the content of the image or figure, and a description of its content oriented to support retrieval of image content and help non-multimodal downstream components to access useful information contained in the image. The annotation engine can be configured to annotate the hierarchical representation (e.g., by annotating nodes in a tree structure) and/or the document chunks (including retrieval content and/or augmentation content).

The RAG system can utilize embedding and/or token-based retrieval to locate relevant document chunks from the document retrieval index for an input query. The retrieved document chunks can be used to generate a final response by providing the query and the document chunks to a sequence processing model such as an LLM. In this manner, the document chunk representation can decouple the content representation used for retrieval and augment the context of a language model, in order to allow the generation of the optimal content to improve precision and recall of the retrieval task, and improve the quality of the goal of any downstream content such as language model answering to a question.

System and methods in accordance with example embodiments of the present disclosure provide a number of technical effects and benefits. A machine-learning system in accordance with example embodiments improves retrieval augmented generation (RAG) systems by addressing the limited context window of large language models (LLMs). By parsing documents into a hierarchical structure and generating semantically coherent chunks, it ensures that relevant information is presented to the LLM within its processing limits. Annotation with LLM-generated questions and keywords enhances retrieval, while handling of oversized structures (summarization, splitting, aggregation) maintains context. The result is improved accuracy, efficiency, and consistency in RAG system outputs, leading to more precise and reliable responses. This invention reduces processing and memory requirements by creating smaller, semantically coherent document chunks tailored to the LLM's context window. This avoids processing irrelevant information, reducing computational load. The hierarchical chunking and annotation also improve retrieval efficiency, minimizing the number of chunks that need processing for a given query, further reducing both processing time and memory usage compared to processing the entire document or using less effective chunking methods.

Much of the following disclosure refers to large language models as specific examples of machine-learned generative models but it will be appreciated that the disclosure is equally applicable to any type of generative model such as other types of sequence processing models. For example, the disclosed technology can be used with large image models, multimodal models, and other types of foundational models. For instance, the generative models can operate in domains other than the text domain, such as image domains, audio domains, biochemical domains, etc. For instance, a sequence processing model may be used to process sequential inputs for robotic controls and other tasks. Similarly, the generative model and/or the downstream applications can be configured to perform any number of tasks. For instance, if the inputs to the generative model and/or a downstream application are images or features that have been extracted from images, the output generated by the generative model for a given image can be scores for each of a set of object categories, with each score representing an estimated likelihood that the image contains an image of an object belonging to the category. As another example, if the inputs to the generative model and/or a downstream application are sensor data, the outputs can be robotic control signals. The system can analyze the distance of generated signals relative to a target domain (e.g., using intended signals) to determine the validity of the generated signals. In each of these examples, a document retrieval index as described can be used to provide additional, relevant, and contextually relevant information to the model with input data.

With reference now to the Figures, example embodiments of the present disclosure will be discussed in further detail.

### Example System and Model Arrangements

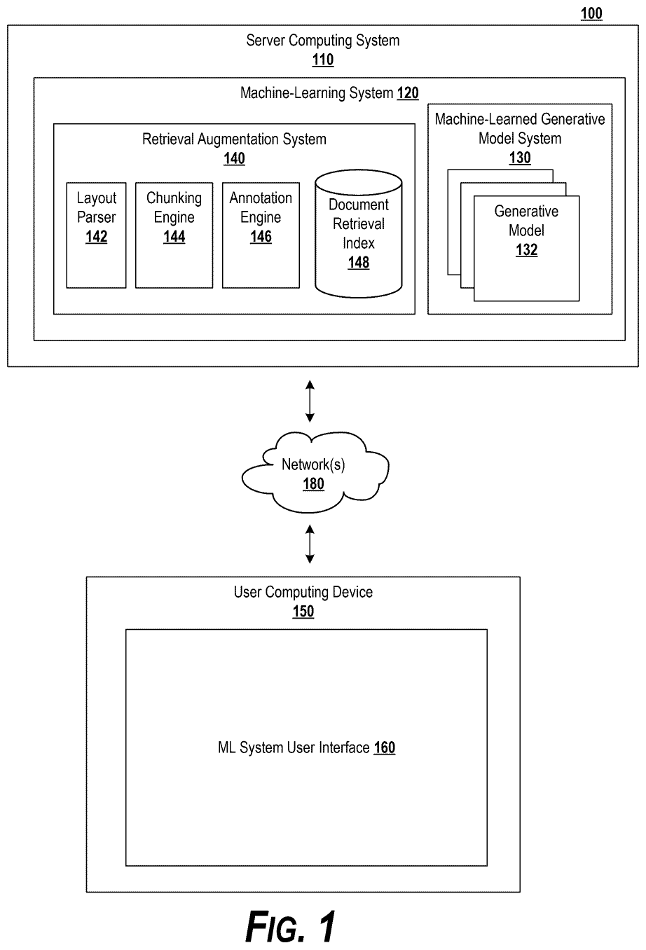

FIG. 1 is a block diagram depicting an example computing environment 100 including a server computing system 110. Server computing system 110 can host or otherwise implement a machine learning system 120, retrieval augmented generation (RAG) system 140 and machine-learned generative model system 130. Server computing system 110 can be accessed by user computing devices such as user computing device 150. Although a single user computing device is shown, any number of user computing devices may access the server computing system 110.

In some examples, server computing system 110 may be implemented by a first computing system and each user computing device 150 can be implemented by a different remote computing system. For instance, computing environment 100 may be implemented as a client server computing environment, including one or more client computing devices implementing each of the user computing devices 150 and one or more server computing devices implementing server computing system 110. In another example, one or more of the downstream applications can be implemented at a server computing system.

The computing systems implementing server computing system 110 and user computing device 150 including downstream applications can be connected by and communicate through one or more networks 180. Any number of user computing devices and/or server computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In some example embodiments, a user computing device 150 can implement a downstream application and can be any suitable device, including, but not limited to, a smartphone, a tablet, a laptop, a desktop computer, or any other computer device that is configured such that it can allow a user to access remote computing devices over a network. The user computing devices can include one or more processor(s), memory, and a display as described in more detail hereinafter. The user computing devices can execute one or more client applications such as a web browser, email application, chat application, video conferencing application, word processing application or the like.

The server computing system 110 can include one or more processor(s) and memory implementing machine learning system 120 and machine-learned generative model system 130. The server computing system can be in communication with the one or more client computing device(s) using a network communication device that is not pictured.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Server computing system 110 can include or otherwise implement a machine learning system 120 including a retrieval augmentation system 140. Machine-learning system 120 can be configured to respond to queries or other inputs received from user computing device 150. Machine-learning system 120 can provide one or more prompts to one or more generative models 132 of generative model system 130 based on the user query. The machine-learning system 120 can generate one or more replies to the user computing device based on the output of the generative models 132 in response to the prompt(s).

Machine-learning system 120 includes a retrieval augmentation system 140. Retrieval augmentation system 140 can include a layout parser 142, a chunking engine 144, and an annotation engine 146. Retrieval augmentation generation (RAG) system 140 can be configured to enhance the capabilities of machine-learned generative model system 130 including generative models 132.

Machine-learned generative model system 130 can include one or more machine-learned generative models 132. Generative models 132 can include any type of machine-learned generative model. In an example, a generative model can include a sequence processing model, such as a large language model including 10B parameters or more. In another example, a generative model can include a language model having less than 10B parameters (e.g., 1B parameters). In yet another example, the generative model can include an autoregressive language model or an image diffusion model. As further examples, a generative model can include a machine-learned text-to-image model, a machine-learned text-to-video model, a machine-learned text-to-audio model, a machine-learned multi-modal model, or any other machine-learned model configured to provide generative content in response to a user query. The generative content generated by generative models 132 can include computer-executable code data, text data, image data, video data, audio data, or other types of generative content. The generative model can be trained to process input data to generate output data. The input data can include text data, image data, audio data, latent encoding data, and/or other input data, which may include multimodal data. The output data can include computer-executable code data, text data, image data, audio data, latent encoding data, and/or other input data.

Retrieval augmentation system 140 can incorporate external knowledge sources into a document retrieval index 148 to provide supplemental information to machine-learned generative model system 130 for responding to a query. Instead of relying solely on the model's internal knowledge, RAG system 140 can retrieve relevant information from a database or knowledge base such as document retrieval index 148, augmenting the model's context with this external information before generating a response. This approach improves the accuracy, factual consistency, and overall quality of the generated output by grounding it in specific, verifiable data. The retrieved information is used to supplement the model's internal knowledge, leading to more informed and reliable responses.

Retrieval augmentation system 140 can generate document retrieval index 148 from documents which can include content including text, images, video, and/or other types of content. Content items can include text data, audio data, image data, video data, latent encoding data (i.e., a multi-dimensional encoding of content), or any other data representative of content capable of processing by a machine-learned model. The documents can include simple text documents, web pages, markup language documents, image files, video files and other document types. The documents can be provided in any suitable document format such as text (e.g., RTF), markup language format (e.g., HTML, DOCX, etc.), portable document format (e.g., PDF), text format (e.g., .rtf), word processing documents, slide documents, etc. The retrieval augmentation system can parse each document into a hierarchical layout structure, generate one or more document chunks based on the hierarchical tree structure, and add annotations to the document chunks for better understanding of the chunk content to improve downstream tasks such as search, retrieval, summary generation, and answer generation, etc.

To generate the document retrieval index 148, each document can first be accessed by layout parser 142. Layout parser 142 can parse the document into a hierarchical representation such as a hierarchical tree structure and/or graph structure according to a layout schema. Several different parsing techniques can be used depending on the input document type. For example, if the input document type is HTML or DOCX, the layout parser can leverage the tags in the document to understand the document structure and represent the structure in a layout schema. For PDF documents, the layout parser can utilize optical character recognition (OCR) and native PDF parsing logic to understand the document structure and represent it in a layout schema.

The layout schema can include a plurality of different block types, with hierarchical relationships between them. For example, the layout schema can include text blocks, table blocks, list blocks, and image blocks. In accordance with example embodiments, the table block and list block can contain the natural hierarchy of the content. The table block can contain table rows and cells. The list block can contain list items. The image block can contain either a link to an image or the binary encoding of an image extracted from the document image. The image block can contain annotations derived from the image content that can be useful to the retrieval of the image and for providing text context to non-multimodal models. In some examples, the layout schema can include different text block types. For example, a text block can be of type paragraph, heading, page header and footer. In some examples, a text block can include or contain other blocks as children, thereby creating a hierarchical representation. A hierarchy for the text block can be created using the information about previous heading blocks. For example, if a paragraph is detected, the layout parser can check if there are unclosed heading blocks (suppose H1 and H2) before the paragraph and create a hierarchical representation (H1->H2->paragraph).

Chunking engine 144 can generate one or more document chunks from the document based on the hierarchical tree structure generated by layout parser 142. For example, chunking engine 144 can utilize the common layout representation from layout parser 142 and create the document chunks based on the hierarchical structure. By way of example, the chunking engine can create document chunks by keeping interconnected content together, thereby producing information dense, rich and concise chunks. Document chunks can be created with content from parsed blocks from layout parsing. By way of example, a document chunk can include content from a reasonable subtree structure of the hierarchical layout. Chunking engine 144 can provide semantically coherent document chunks. By way of example, a table block can be placed in a chunk, to the extent possible, rather than merging it with other blocks by splitting it to meet the token limit unnecessarily. Chunking engine 144 can use the known structure preserved in the layout representation to transform the structure, such as summarizing content across a large section, splitting a single table into multiple tables, but preserving headers and related rows and columns together, or aggregating and selecting information (Co-Table), so relevant information is preserved even as the original content is split and reduced in terms of tokens used.

Annotation engine 146 can annotate document chunks and/or layout information. For example, a document chunk can be annotated with LLM-generated questions answerable from the chunk content and keywords to enhance retrieval. In some examples, large sections and tables can be summarized in order to improve retrieval and provide useful context information to downstream components. In some examples, images can be annotated with questions that can be answered with the content of the image or figure, and a description of its content oriented to support retrieval of image content and help non-multimodal downstream components to access useful information contained in the image.

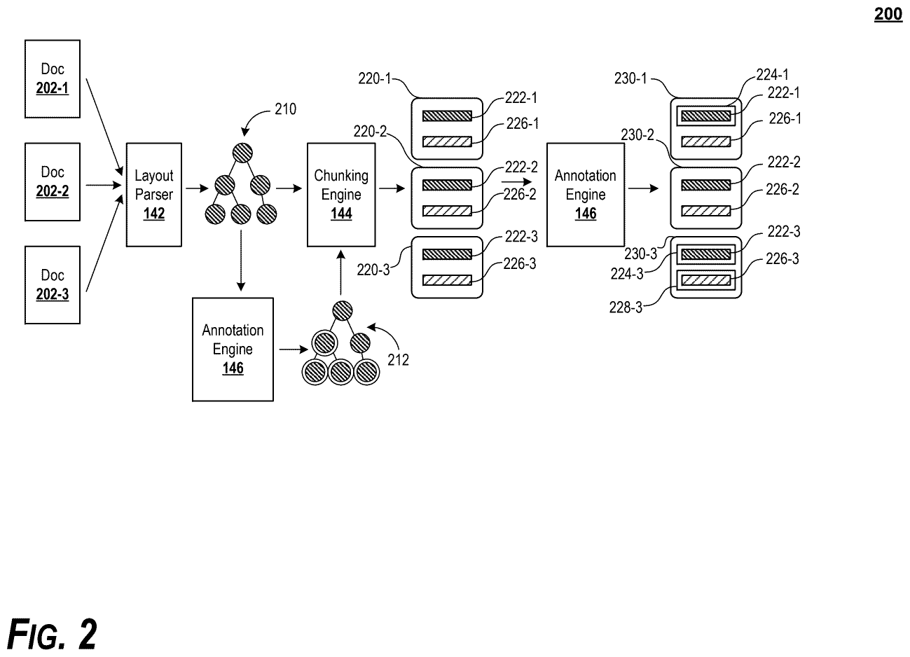

FIG. 2 is a block diagram depicting an example computing environment 200 including processing of an example set of documents 202 by a retrieval augmentation system (RAG) 140 in accordance with example embodiments of the present disclosure. In this example, RAG system 140 can process documents 202-1, 202-2, and 202-3 to generate a set of annotated document chunks 230 for each document. Documents 202 can include any type of content and be provided in any suitable format such as portable document formats, markup language documents, image formats, video formats, etc.

Layout parser 142 accesses a document (e.g., document 202-1) and parses the content of the document according to a layout schema to generate a hierarchical representation 210 of the document. Layout parser 142 can be configured to detect and preserve the structure of headers, footers, lifts, and tables. Layout parser 142 can preserve the reading order between those elements. Hierarchical representation 210 can include a hierarchical tree structure in example embodiments. Hierarchical representation 210 can include a plurality of different block types having hierarchical relationships between them including text blocks, table blocks, list blocks, and image blocks. Layout parser 142 can detect and include images, charts, figures, and other document content in parsed document blocks.

In an example implementation, layout parser 142 can include a layout detector. The document layout can be inferred using visual cues such as different font sizes, indentations, line breaks, splits of pages into multiple columns, etc. The document layout can also be inferred using semantic understanding of the document. Document content can be partitioned using semantic cohesiveness of the content and hierarchical relationships between those partitions can be inferred using semantic understanding. This can be particularly useful in text documents (.txt files). In example implementations, layout detection can be performed using visual cues and/or semantic understanding. Layout detection can vary depending on file formats in example embodiments. For example, file formats such as HTML, DOCX, PPTX, LATEX can contain structural information in tags, which can be parsed to detect the layout information. There can be tags for heading, paragraph, bold text, italicized text, line breaks, table and lists, etc. In some examples, a document format can include a list of XML documents where elements can be nested. An XML document tree can be parsed using tags to detect a document layout. The various formats allow flexibility in representing content. For example, style and javascript can be used to render text content as a table without using any table tags. As such, it may not always be possible to detect the document structure just by tags. In such cases, a document can be converted to another format (e.g., PDF) and then layout elements can be detected using an OCR engine. In some cases, a file format may not contain extra metadata for structural elements (e.g., image-only or scanned PDFs). In such cases, an OCR engine can be used to detect the content and structural elements.

Layout parser 142 can represent the layout of the input document in different manners. The layout of the document can represent the entities and their relationships. For examples, entities can include headings, paragraphs, margins, columns, tables, lists, and/or combination of these. Example relationships can include neighbor, adjacent, and reference.

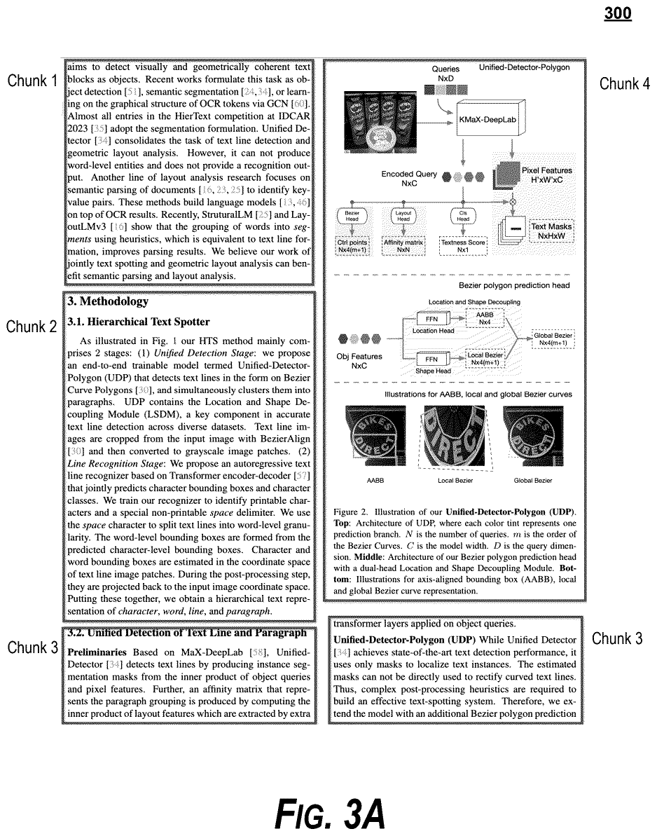

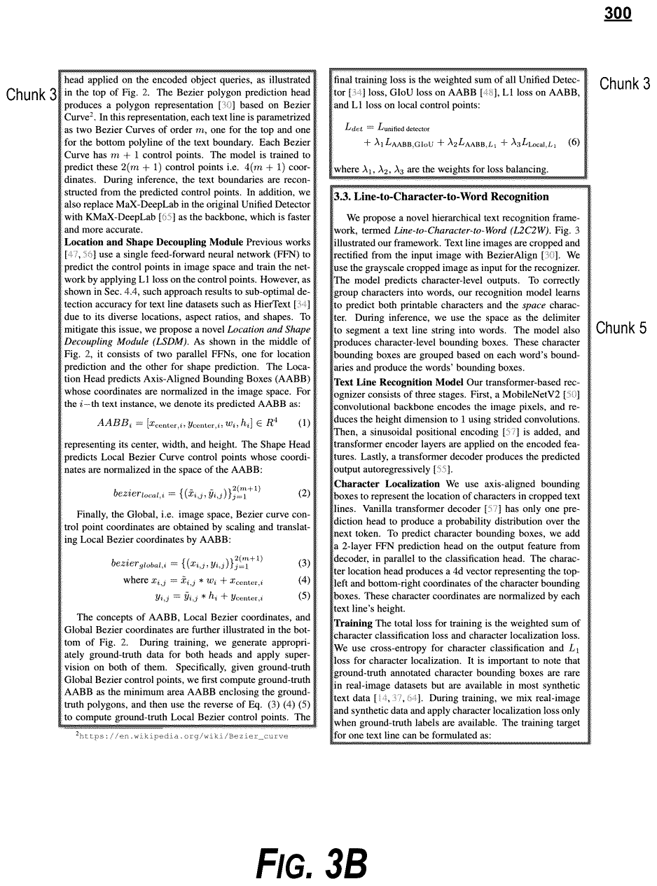

FIGS. 3A and 3B depict an example of content (e.g., an image) and an example of a hierarchical representation of the content including entities and relationships in accordance with an example embodiment of the present disclosure. With reference to FIG. 3A, section headings can be separate entities and the paragraphs following the headings can be separate layout entities. List items within a paragraph can be layout entities. Section headers along with paragraphs can also be layout entities. The most granular entity in this example is a block of text of single type (h1, h2, paragraph). These text entities can be combined to construct structural elements like lists, tables and sections. The combination is only for the entities which carry semantic relationships in example embodiments. Various entity relationships can be defined. For example, a parent child relationship can be defined. For a visual representation, a parent layout entity can encapsulate children layout entities. Visual representation can be done by creating sections of content by separating them from each other by spaces, newlines or columns. Visual representation can also be done by changing alignment of the content. A parent entity can be represented by creating a container entity which contains all children entities. A sibling relationship can be defined where the entities sharing the same parent entity will have sibling relationships. An adjacent relationship can be defined where the entities which are visually adjacent (left, right, up and down) will have adjacent relationships.

A reference relationship can be defined such that when a part of a document references/mentions another part of the document, reference relationships are created between the layout entities from those parts.

In the example of FIG. 3, sibling (or neighbor) relations can be defined for the section header to the following paragraphs. For example, the section 1 header and the following paragraphs can be defined with a sibling relationship. Section 1 and section 2 can be defined with sibling relationships. “Section 1” to “Section 1 heading” and “Section 1 paragraph” can be defined with parent child relationships. “Section 2” to “Section 2.2” can be defined with adjacent relationships. It is noted that “Section 1 paragraph” to “Section 2” may not have sibling or parent child relationships. Instead, they may be defined with adjacent relationships. If a block of text references an entity in the document, it can be defined with a reference relationship.

Various layout structures can be used. In an example embodiment, a hierarchical structure with composite blocks can be used. In another example, a hierarchical structure without composite blocks can be used. In yet another example, a hierarchical structure with identification (ID) references to related entities can be used. As another example, a flattened structure with related block identification references can be used.

In an example implementation, layout parser 142 can include a layout processor that is configured to process the detected layout blocks to create a compact and common layout representation. The layout processor can ensure that content nodes are not fragmented while preserving the document structure. At a leaf level, the structure can include text blocks. At higher levels, the structure can include list blocks or table blocks or composite blocks. The list and table blocks can include a well-defined structure. A composite block can take many forms. The layout processor can create composite blocks and add relationship pointers to each block. Depending on how the input document is processed, layout processing can be completed during the layout detection step or after the layout detection step. For example, while parsing the HTML document, content elements like headings, paragraphs, lists and tables can be detected and their containing structural elements like div, section, body and main, etc. can also be detected. In this case, the layout detection has visibility into parent-child and sibling relationships. For other documents such as PDFs and for reference relationships in markup languages such HTML, DOCX (zipped XML), the OCR engine can detect content entities like heading, paragraphs, list and tables. It can also detect parent-child and positional relationships. The layout processor can include logic to process the relationship information from the OCR engine and create the layout representation.

Referring again to FIG. 2, the hierarchical representation generated by layout parser 142 is accessed by chunking engine 144 and annotation engine 146. Annotation engine 146 can optionally annotate the hierarchical representation to generate an annotated hierarchical representation 212 of the input document. The annotated hierarchical representation 212 can include annotations 213 appended to one or more nodes of the hierarchical representation.

Chunking engine 144 accesses hierarchical representation 210 and optionally the annotated hierarchical representation 212. Chunking engine 144 can be configured to represent information that is present in a parsed document. Chunking engine 144 can generate document chunks that contain content such as text used for indexing (retrieval), and content exposed to downstream systems (augmentation) such as search, answer generation etc. Chunking engine 144 can perform chunking on images by using image block annotations in retrieval content to allow retrieval of chunks containing image content. Chunking engine 144 can use image annotations in augmented content provided to downstream systems that can operate on text content. The chunking engine 144 can include image bytes inside of chunks to allow multimodal downstream system to access an image directly.

Chunking engine 144 generates one or more document chunks 220 from the input document 202 based on hierarchical representation 210 and/or annotated hierarchical representation 212. In this example, chunking engine 144 generates three document chunks 220-1, 220-2, and 220-3. Each document chunk includes retrieval content 222 and augmentation content 226. Document chunk 220-1 includes retrieval content 222-1 and augmentation content 226-1. Document chunk 220-2 includes retrieval content 222-2 and augmentation content 226-2. Document chunk 220-3 includes retrieval content 222-3 and augmentation content 226-3. In example embodiments, retrieval content 222 can include content obtained from the input document directly. Augmentation content 226 can include supplemental or additional content that is derived from the input document. For example, augmentation content can include summarization content in example embodiments. For instance, the augmentation content 226 can include a summary of a large section of text. The augmentation content can be generated by providing the document content to a sequence processing model which can process the content and generate a textual summary. In another example, the augmentation content can include keywords for a section of text or other content. In yet another example, the augmentation content can include questions that can be answered with the content from the blocks. The questions can be generated using a sequence processing model by providing a prompt to the sequence processing instructing the model to summarize the content.

Annotation engine 146 accesses the document chunk(s) 220 and generates annotated document chunks 230. Annotation engine 146 can generate retrieval content annotations 224 for retrieval content 222 and augmented content annotations 228 for augmented content 226. In this example, annotation engine 146 generates a retrieval content annotation 224-1 for retrieval content 222-1 and a retrieval content annotation 224-3 for retrieval content 222-3. Annotation engine generates an augmented content annotation 228-3 for augmented content 226. Various types of annotations 224 and 228 can be applied to retrieval content 222 and 226, respectively. In some examples, an annotation 224 or 228 can include augmentation content generated by the chunking engine 144. Layout content and document chunks can be annotated. For example, text-based blocks such as text, table, and list block can be annotated with LLM-generated questions which are answerable from the block content and keywords to enhance retrieval. Large sections of text and/or tables can be summarized in order to improve retrieval and provide useful context information to downstream components. Images can be annotated with questions that can be answered with the content of the image or figure, and a description of its content oriented to support retrieval of image content and help non-multimodal downstream components to access useful information contained in the image.

In an example implementation, table annotations can include annotations generated for table content. Table annotations can include items such as queries, keywords, and summaries. Queries can include questions generated by a large language model that can be answered from the table content. Keywords can include keywords extracted from the table using a large language model. Summaries can include summaries of the table content generated by a large language model. Annotations can be generated from a table block and attached to the table block to generate annotated table blocks. The content provided to an annotator can contain the content from a table. Annotated chunks with tables can also be used. Annotations can be generated from chunks that contain one or more tables. Table annotations can be attached to the chunk. The content provided to the annotator can contain content from other types of blocks and multiple tables.

Image annotations can be provided in some examples. For example, all or some of the content of documents can be contained in pictures, charts, diagrams, etc. In some of these cases it may be beneficial to preserve more complex structures beyond paragraphs lists and tables to fully capture the information contained. The position of the text and the presence of other elements such as boxes, lines, colors, etc., might express relevant information. Image text annotations can be used as input for answer generation. A multimodal large language model (LLM) can use chunk text and image content for answer generation.

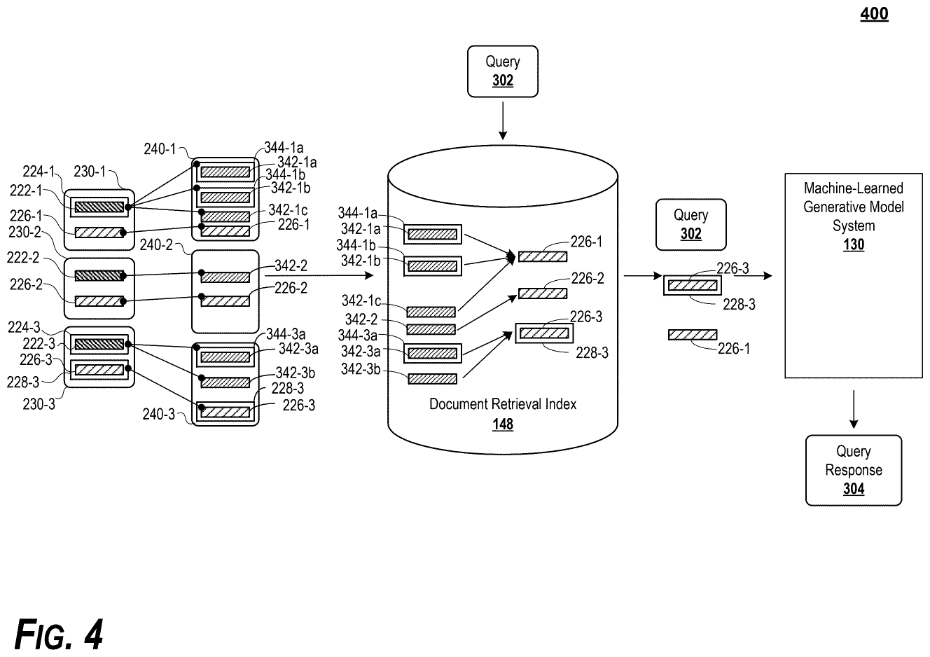

FIG. 4 is a block diagram depicting an example computing environment 400 including processing of an example query 302 to generate a query response using a document retrieval index 148 in accordance with example embodiments of the present disclosure. FIG. 4 depicts additional details of indexing annotated document chunks 230 to be used for retrieval and downstream tasks such as search, etc. In this example, RAG system 140 accesses document chunks 230-1, 230-2, and 230-3. RAG system 140 generates indexed document chunks 240-1, 240-2, and 240-3 from document chunks 230-1, to 230-2, and 230-3, respectively.

Indexed document chunk 240-1 includes annotated indexed segments that are generated from the annotated retrieval content. Specifically, indexed document chunk 240-1 includes a first annotated index segment that includes an indexed segment 342-1A and a corresponding annotation 344-1A. Indexed document chunk 240-1 includes a second annotated index segment that includes an indexed segment 342-1B and a corresponding annotation 344-1B. The first and second annotated index segments are generated from retrieval content 222-1 and the corresponding annotation 224-1. Indexed document chunk 240-1 also includes an indexed segment 342-1C which is not annotated. Indexed segment 342-1C is generated from retrieval content 222-1. Indexed document chunk 240-1 also includes augmentation content 226-1 which is retrieved directly from annotated document chunk 230-1.

Indexed document chunk 240-2 includes indexed segments that are generated from the retrieval content 222-2 and the augmentation content 226-1. Retrieval content 222-2 is an example of non-annotated retrieval content and augmentation content 226-2 is an example of non-annotated augmentation content. Accordingly, indexed document chunk 240-1 includes an indexed segment 342-2 for the retrieval content 222-2 and the non-annotated augmentation content 226-2 without annotation.

Indexed document chunk 240-3 includes annotated indexed segments that are generated from annotated retrieval content and annotated augmentation content. Specifically, indexed document chunk 240-3 includes a first annotated index segment that includes an indexed segment 342-3A and a corresponding annotation 344-3A. Indexed document chunk 240-3 includes a non-annotated indexed segment 342-3B. Indexed document chunk 240-1 also includes annotated augmentation content including augmentation content 226-3 and corresponding annotation 228-3.

The indexed document chunks 240 can be stored in document retrieval index 148 using one or more storage techniques. FIG. 4 depicts an example where the indexed segments of the document chunks are mapped to the corresponding augmentation content. In this example, the annotated indexed segment including indexed segment 342-1a and annotation 344-1a maps to augmentation content 226-1. The annotated indexed segment including indexed segment 342-1b and annotation 344-1b also maps to augmentation content 226-1. The non-annotated indexed segment 342-1c maps to augmentation content 226-2. The non-annotated indexed segment 342-2 maps to augmentation content 226-2. The annotated indexed segment including indexed segment 342-3a and corresponding annotation 344-3a maps to the annotated augmentation content including augmentation content 226-3 and corresponding annotation 228-3. The non-annotated indexed segment 342-3b also maps to the to the annotated augmentation content including augmentation content 226-3 and corresponding annotation 228-3.

FIG. 4 further depicts processing of a query 302 by the retrieval augmentation system to retrieve relevant document chunks that can be provided to the machine-learned generative model system with the query. Query 302 can be processed by the retrieval augmentation system using a retrieval process to identify relevant document chunks based on the indexed segments and augmentation content. In this example, the system determines that augmentation content 226-1 and augmentation content 226-3 including annotation 228-3 are relevant to query 302. The retrieval process can identify the relevant content based on the indexed segments including the corresponding annotations and/or from the augmentation content including the corresponding annotations.

The retrieval augmentation system can provide query 302 augmentation content 226-3, annotation 228-3, and augmentation content 226-1 to the machine learning generative model system 130. In one example the content and annotations can be provided in an input prompt along with query 302. One or more generative models 132 of the generative model system 130 can process the input prompt including the content and query to generate one or more query responses 304.

In accordance with example embodiments, document retrieval index 148 can store a first set of document chunks that are optimized for processing by a machine-learned model and a second set of document chunks that are optimized for retrieval. For example, in response to a query, the system can identify one or more relevant document chunks using the first plurality of document chunks that are optimized for retrieval. Once the document chunks are identified, the system can access corresponding document chunks from the second set of document chunks that are optimized for processing by the large language model. As such the system can generate a first plurality of document chunks optimized for processing by a sequence processing model and generate a second plurality of document chunks that are optimized for retrieval. In response to a query, the system can retrieve one or more of the second plurality of document chunks based on the query. The system can then identify one or more of the first plurality of document chunks that correspond to the one or more of the second plurality of document chunks. The system can then provide the query to the one or more of the first plurality of document chunks as input to a sequence processing model. The system can then generate using the sequencing processing model, at least one output based on processing the query and the one or more of the first plurality of document chunks.

### Example Methods

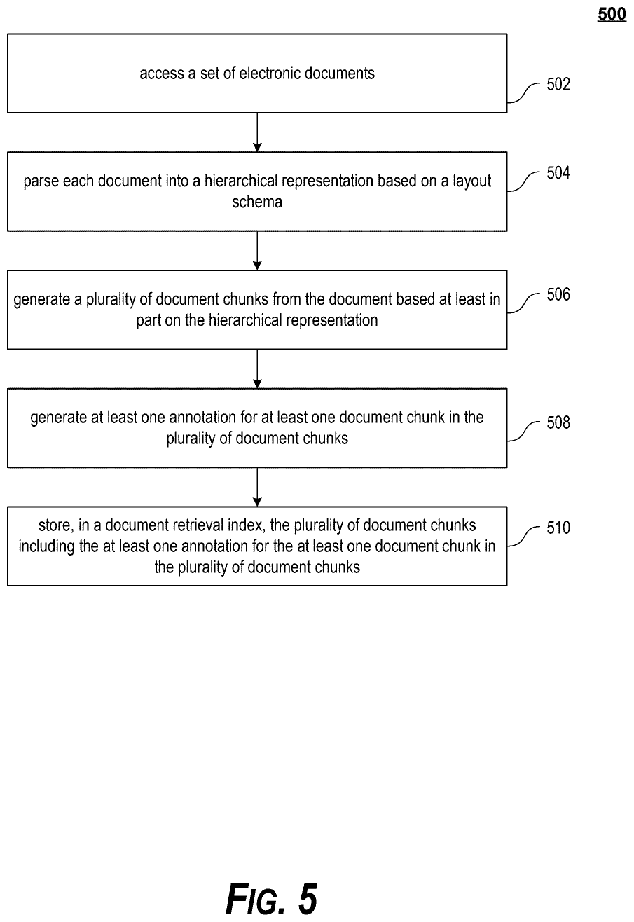

FIG. 5 is a flowchart diagram depicting an example method 500 of generating a document retrieval index for a retrieval augmentation generation system according to example embodiments of the present disclosure. One or more portion(s) of example method 500 and the other methods described here can be implemented by a computing system that includes one or more computing devices such as, for example, a machine-learned computing system as described herein. Each respective portion of example method 500 can be performed by any (or any combination) of one or more computing devices. Moreover, one or more portion(s) of example method 500 can be implemented on the hardware components of the device(s) described herein, for example, to process one or more documents to generate a document retrieval index. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include accessing a set of documents. The documents can include electronic documents such as markup language documents (e.g., DOCX or HTML files), Portable Document Format (PDF) documents, images, videos, etc. Documents can include any type of content, including but not limited to, text, tables, charts, figures, images, video, etc.

At 504, example method 500 can include parsing each of the electronic documents into a hierarchical representation based on the layout schema. Parsing each electronic document can include detecting and preserving the structure of headers, footers, tables, etc. in the document. Parsing can also include preserving the reading order between those elements. Parsing can further include detecting text boxes and converting tables to other types of blocks. Parsing can include detecting the layout including the content elements such as text, tables, lists, images, etc. as well as structural elements such as headings, line breaks, headers, footers, etc. Layout detection can include using visual cues and/or semantic understanding of the document. Layout detection can vary depending on file formats in example embodiments. The layout can be represented in different manners. The layout can represent the entities and their relationships. For examples, entities can include headings, paragraphs, margins, columns, tables, lists, and/or combination of these. Example relationships can include neighbor, adjacent, and referenced.

At 506, example method 500 can include generating, for each of the electronic documents, a plurality of document chunks from the electronic document based on the hierarchical representation. Document chunks generated from a hierarchical representation can include one or more retrieval segments (e.g., retrieval content segments) and/or one or more augmentation segments (e.g., augmentation content segments). Retrieval segments can include content such as text and/or other types of content from an electronic document that the machine-learned generative model system is configured to retrieve based on a query. Augmentation segments can include content that the machine-learned generative model system (e.g., retrieval augmentation system) is configured to provide as augmentation to a query.

At 508, example method 500 can include generating at least one annotation for at least one document chunk in the plurality of document chunks. One or more annotations can be generated for a document chunk. For example, annotations can be generated for retrieval segments (e.g., retrieval content segments) of a document chunk and/or for augmentation segments (e.g., augmentation content segments) of the document chunk. Annotation can include augmentation content generated by the chunking engine 144. Layout content and document chunks can be annotated. For example, text-based blocks such as text, table, and list block can be annotated with LLM-generated questions which are answerable from the block content and keywords to enhance retrieval. Large sections of text and/or tables can be summarized in order to improve retrieval and provide useful context information to downstream components. Images can be annotated with questions that can be answered with the content of the image or figure, and a description of its content oriented to support retrieval of image content and help non-multimodal downstream components to access useful information contained in the image. In an example implementation, table annotations can include annotations generated for table content. Table annotations can include items such as queries, keywords, and summaries.

At 510, example method 500 can include storing, in a document retrieval index, the plurality of document chunks including the at least one annotation for the least one document chunk in the plurality of document chunks. The document retrieval index can include retrieval content and/or augmentation content. In some examples, the index can included indexed segments generated from the retrieval and/or augmentation content of the document chunks in the index. The indexed segments can map to retrieval content in an document chunk and/or augmentation content in the document chunk. The indexed segments can be annotated indexed segments in example embodiments.

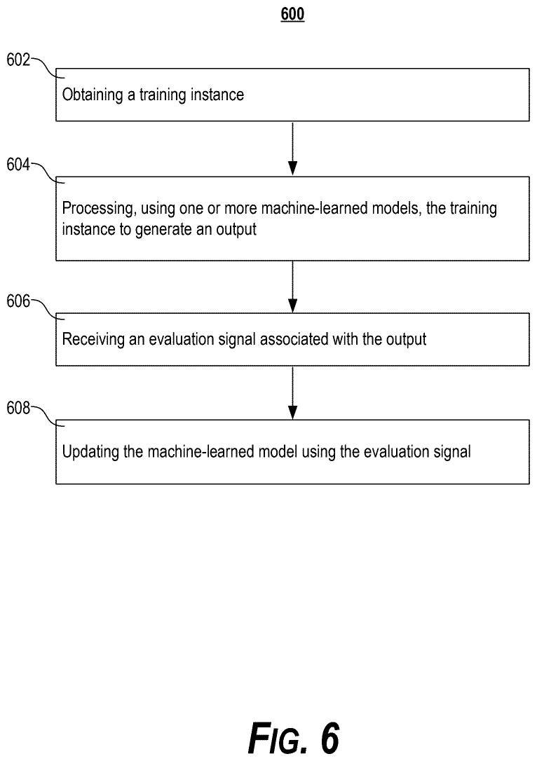

FIG. 6 depicts a flowchart of a method 600 for training one or more machine-learned models according to aspects of the present disclosure. For instance, an example machine-learned model can include a core sequence processing model, such as a foundational large language model (LLM).

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

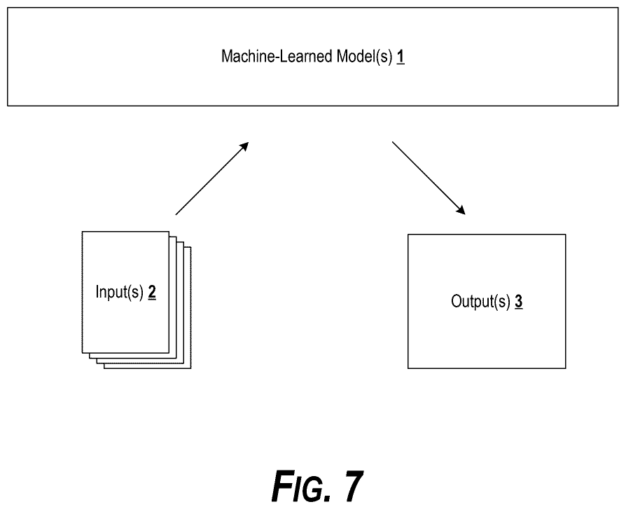

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism, such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

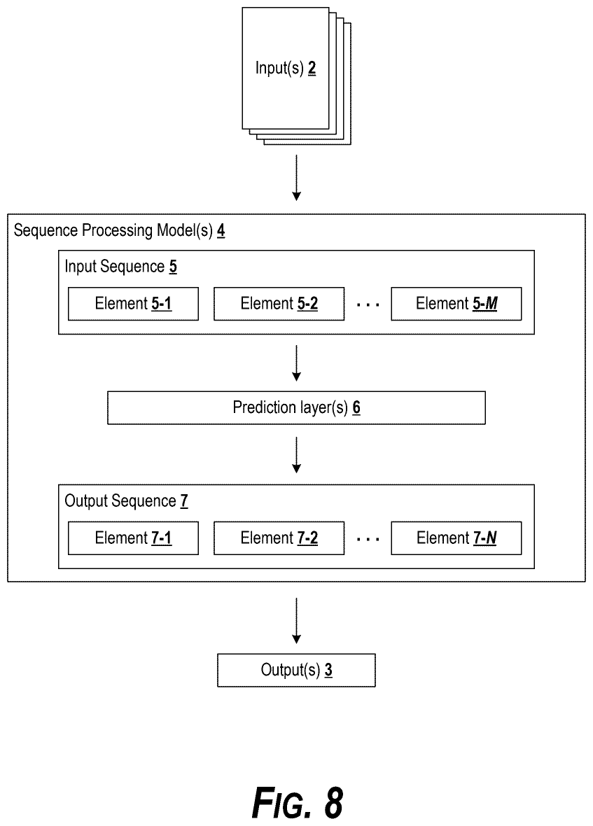

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

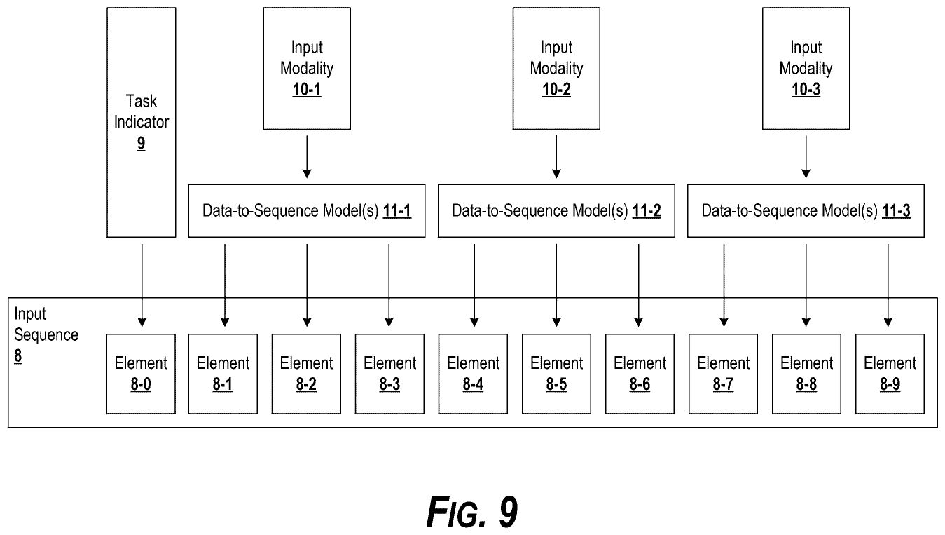

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

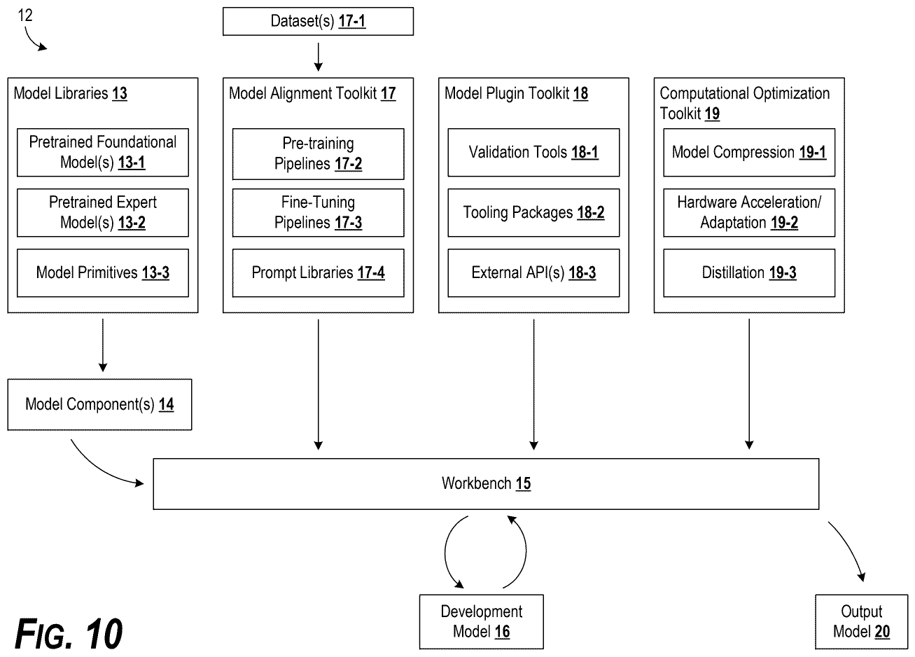

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

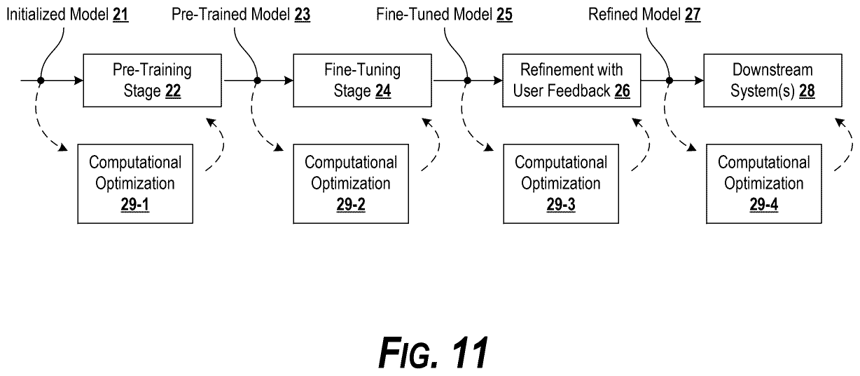

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

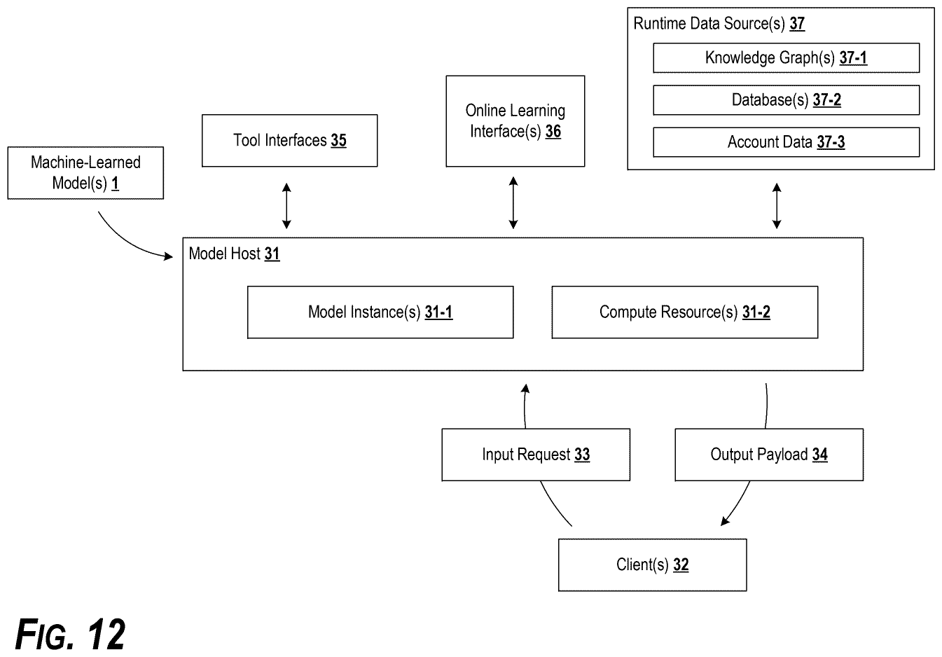

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

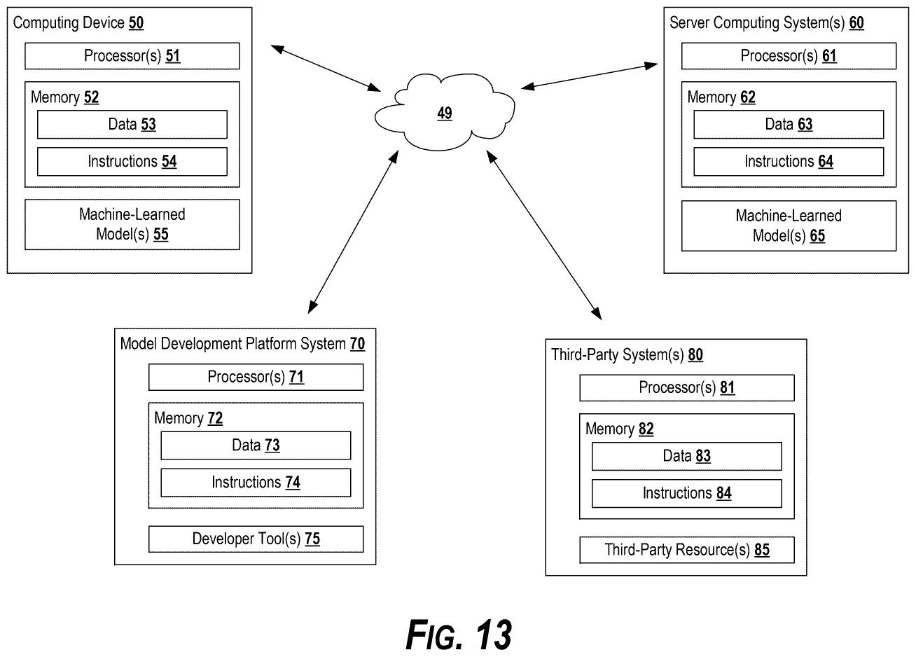

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

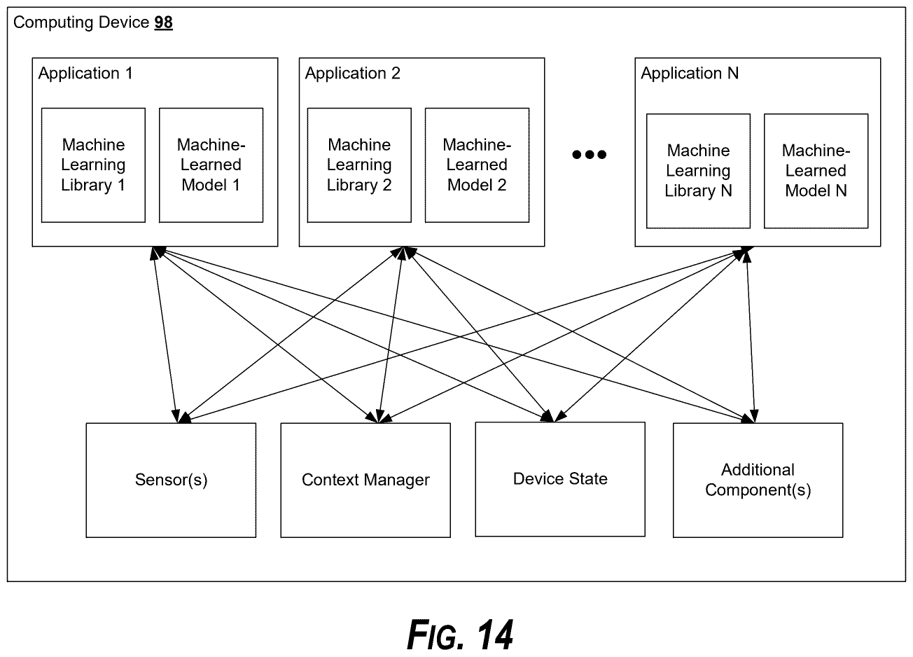

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 17, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

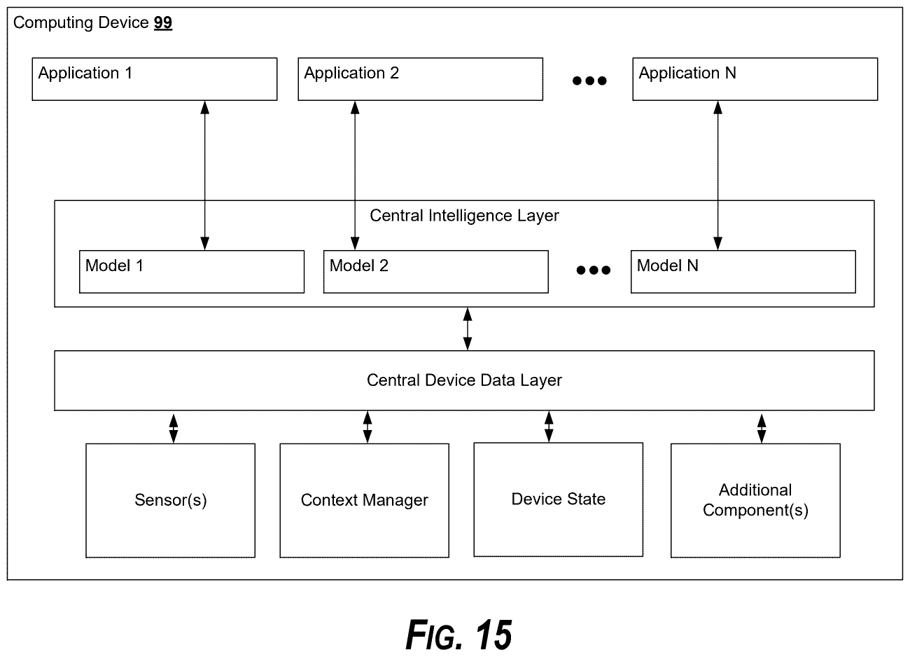

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of generating an index for machine-learning retrieval augmented generation systems, the method comprising, by a computing system comprising one or more computing devices:
accessing a set of documents;
for each document in the set of documents;
parsing the document into a hierarchical representation based on a layout schema;
generating a plurality of document chunks from the document based at least in part on the hierarchical representation;
generating at least one annotation for at least one document chunk in the plurality of document chunks; and
storing, in a document retrieval index, the plurality of document chunks including the at least one annotation for the at least one document chunk in the plurality of document chunks.

2. The computer-implemented method of claim 1, wherein generating at least one annotation for at least one document chunk in the plurality of document chunks comprises:
generating a first annotation for a first document chunk, the first annotation linking the first document chunk to a second document chunk.

3. The computer-implemented method of claim 1,wherein the hierarchical representation includes a plurality of block types.

4. The computer-implemented method of claim 3, wherein the plurality of block types include:
a text block;
a table block;
a list block; and
and image block.

5. The computer-implemented method of claim 4, wherein:
the list block contains a list of items;
the table block contains table rows and cells;
the image block contains at least one of a link to an image or a binary encoding of the image; and
the text block includes at least one type block type including a paragraph, a heading, or a page and footer.

6. The computer-implemented method of claim 4, wherein:
the text block is annotated with questions generated by a sequence processing model based on content from the text block.

7. The computer-implemented method of claim 4, wherein:
the image block is annotated with questions generated by a sequence processing model based on an image from the image block.

8. The computer-implemented method of claim 1, wherein generating a plurality of document chunks comprises:
augmenting content of at least one document chunk with augmented content.

9. The computer-implemented method of claim 1, wherein augmenting content of at least one document chunk with augmented content comprises:
providing the at least one document chunk to a sequence processing model;
generating, with the sequence processing model, the augmented content based on content of the at least of the plurality of document chunks; and
appending the augmented content to the at least one document chunk.

10. The computer-implemented method of claim 1, wherein storing, in a document retrieval index, the plurality of document chunks includes:
storing the plurality of document chunks as text enabling a token search of the plurality of document chunks; and
embedding the plurality of document chunks in an embedding space enabling an embedding based search of the plurality of document chunks.

11. The computer-implemented method of claim 1, further comprising:
receiving a query;
retrieving one or more of the plurality of document chunks based on the query;
providing the query and the one or more of the plurality of document chunks as input to a sequence processing model; and
generating, with the sequence processing model, at least one output based on processing the query and the one or more of the plurality of document chunks.

12. The computer-implemented method of claim 11, wherein:
the sequence processing model includes a large language model.

13. The computer-implemented method of claim 1, wherein:
the plurality of document chunks from the document is a first plurality of document chunks optimized for processing by a sequence processing model; and
the method further comprises generating a second plurality of document chunks from the document based on the hierarchical representation, where the second plurality of document chunks are optimized for retrieval.

14. The computer-implemented method of claim 13, further comprising:
receiving a query;
retrieving one or more of the second plurality of document chunks based on the query;
identifying one or more of the first plurality of document chunks that correspond to the one or more of the second plurality of document chunks;
providing the query and the one or more of the first plurality of document chunks as input to a sequence processing model; and
generating, with the sequence processing model, at least one output based on processing the query and the one or more of the first plurality of document chunks.

15. The computer-implemented method of claim 1, further comprising:
generating at least one annotation for at least a portion of the hierarchical representation of the document.

16. A computing system, comprising:
one or more processors; and
one or more non-transitory computer-readable media that collectively store instructions that, when executed by the one or more processors, cause the one or more processors to perform operations, comprising:
accessing a set of documents;
for each document in the set of documents;
parsing the document into a hierarchical representation based on a layout schema;
generating a plurality of document chunks from the document based at least in part on the hierarchical representation;
generating at least one annotation for at least one document chunk in the plurality of document chunks; and
storing, in a document retrieval index, the plurality of document chunks including the at least one annotation for the at least one document chunk in the plurality of document chunks.

17. The computing system of claim 16, wherein the operations further comprise:
generating at least one annotation for at least a portion of the hierarchical representation of the document.

18. The computing system of claim 16, wherein augmenting content of at least one document chunk with augmented content comprises:
providing the at least one document chunk to a sequence processing model;
generating, with the sequence processing model, the augmented content based on content of the at least of the plurality of document chunks; and
appending the augmented content to the at least one document chunk.

19. The computing system of claim 16, wherein the operations further comprise:
receiving a query;
retrieving one or more of the plurality of document chunks based on the query;
providing the query and the one or more of the plurality of document chunks as input to a sequence processing model; and
generating, with the sequence processing model, at least one output based on processing the query and the one or more of the plurality of document chunks.

20. One or more non-transitory computer-readable media that collectively store instructions that, when executed by one or more processors, cause the one or more processors to perform operations, comprising:
accessing a set of documents;
for each document in the set of documents;
parsing the document into a hierarchical representation based on a layout schema;
generating a plurality of document chunks from the document based at least in part on the hierarchical representation;
generating at least one annotation for at least one document chunk in the plurality of document chunks; and
storing, in a document retrieval index, the plurality of document chunks including the at least one annotation for the at least one document chunk in the plurality of document chunks.
